(19) United States
(12) Patent Application Publication
(10) Pub. No.: US 2003/0171972 A1
(43) Pub. Date: Sep. 11, 2003

(54) Scheduling system and method

(76) Inventor: James Heskin, Richardson, TX (US)

Correspondence Address: TEXAS INSTRUMENTS INCORPORATED, P O BOX 655474, M/S 3999, DALLAS, TX, 75265

(21) Appl. No.: 10/352,653

(22) Filed: Jan. 28, 2003

Related U.S. Application Data
(60) Provisional application No. 60/352,540, filed on Jan. 28, 2002.

(51) Int. Cl. G06F 17/60

(52) U.S. Cl. 705/9

(57) ABSTRACT

Wafer fab scheduling/planning rule structure including reports for and heuristic bottleneck forecasting for real-time rescheduling.

### CROSS-REFERENCE TO RELATED APPLICATIONS

This application claims priority from provisional applications: Serial No. 60/352,540, filed Jan. 28, 2002.

### BACKGROUND OF THE INVENTION

The invention relates to semiconductor device manufacturing, and more particularly to scheduling in a wafer fab.

Manufacture of integrated circuits typically includes repeated application of a few processing steps such as depositions, patternings, and etches. The processing tools will be shared by the manufacture of various devices, and the efficient use of the tools provides a scheduling challenge. Indeed, automation software to control overall factory operation becomes complicated by the demand for use of real-time information about the various tools and work in progress while simultaneously attempting to optimize throughput according to plans.

For example, Johnston, Reconciling High-Speed Scheduling with Dispatching in Wafer Fabs,.2001 IEEE Int. Semi. Manuf. Symp. 107 illustrates a splitting of scheduling into long-term and short-term schedule generation; Lu et al, Efficient Scheduling Policies to Reduce Mean and Variance of Cycle-Time in Semiconductor Manufacturing Plants, 7 IEEE Tran.Semi.Manuf. 374 (1994) describe scheduling policies to reduce cycle time fluctuation by particular choices of slack variables together with least slack scheduling; and U.S. Pat. Nos. 5,838,565 and 5,930,137 disclose batch tool control methods within a wafer fab.

However, the complexity of known wafer fab or other factory scheduling methods prevents effective real-time usage.

### SUMMARY OF THE INVENTION

The present invention provides manufacturing scheduling with parallel information sources (reports) at differing update rates for rescheduling, low-complexity dynamic bottleneck forecasting, parallel processing reports, a bottleneck slack ratio acceleration, resource pull scheduling, and/or lot priority using reticle trains.

This has advantages including essentially real-time rescheduling to enhance factor (wafer fab) usage.

### BRIEF DESCRIPTION OF THE DRAWINGS

FIG. 1 shows a preferred embodiment rule structure.

FIG. 2 is a text sample setup of preferred embodiment.

FIG. 3 illustrates bottleneck forecasting.

FIG. 4 demonstrates a method to maximize tool usage on tools with a test/process operation.

FIG. 5 represents forming batches for tools with max/min requirements in amount of material.

### DETAILED DESCRIPTION OF THE PREFERRED EMBODIMENTS

1. Overview

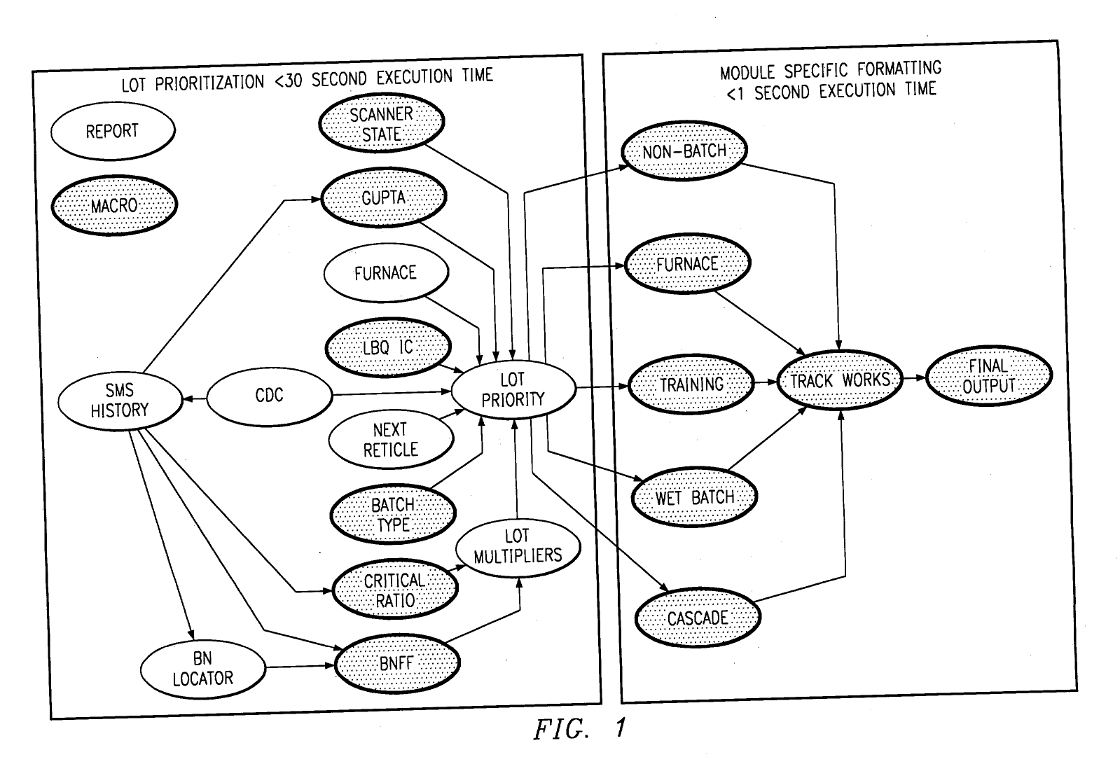

Preferred embodiment methods provide scheduling/planning for varying product lots in a wafer fab containing multiple processing tools. FIG. 1 illustrates a preferred embodiment scheduling rule structure. The scheduling rule is run (execution of code for tool control) in a production environment where various portions of the rule on current lots are run on different time intervals which permits the rule execution to be staggered into various run cycles allowing the total time required to complete one cycle to be reduced.

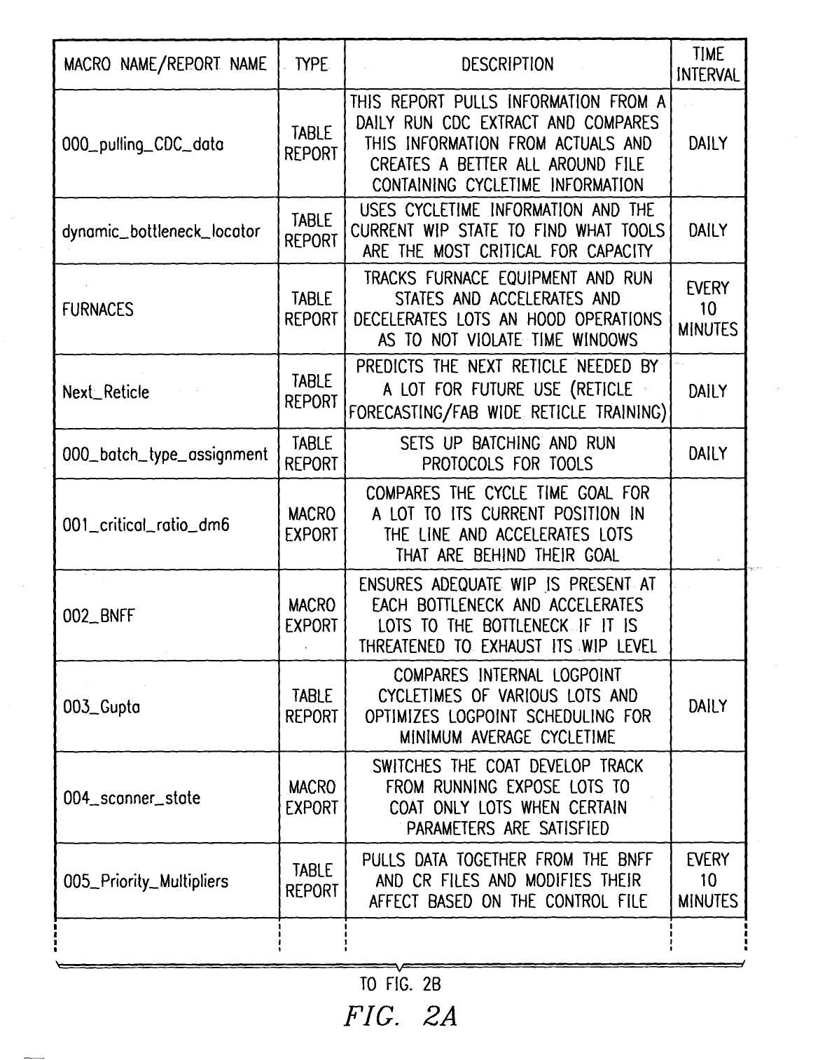

This separation of the rule into portions derives from creation of various reports (see FIG. 2) that analyze various specifics to special case lots and logpoints. Those special cases would include, for example, time windowed lots and other logpoint specific information that would allow the rest of the code to be fed information such as whether a logpoint was capable of handling additional lots and when to start additional lots. These reports are then setup to execute at a timing that reflected the pace of realistic changes within the factory. Each of these reports generates an import file that acts as a temporary cache for that particular piece of information so that the next piece of code can execute more frequently than the reports feeding it with no loss of relevant information.

This decrease in execution time follows from the fact that all of the report information is compiled, formatted, and fed to a rollup report that ranks and assembles lot information based on the cached information. This lot information report then generates another file that is used as the basis for all tool specific formats. This new import file contains all of the relevant SMS lot information in addition to any calculated values needed for some of the higher logic scheduling functions such as the Bottleneck Slack Factor (Bottleneck Feed Factor, BNFF), Slack Ratio (Critical Ratio), Gupta value, reticle training, and furnace logic.

When the lot information report has been generated, the actual rule executes using the new report for the lot information. Using the cached information, the rule splits the lots up into separate types of scheduling based on the tools that the lots will be run on. The rule then generates a heuristic “optimum” schedule with this information for each of the tool types and compiles all of that information back together into one data stream for final dispatch and display. This new schedule is then compared to the tool states to ensure whether a tool can currently run material and what type of material it is capable of running, scheduling appropriate quals when applicable, and then outputs a schedule by tool.

This compartmentalization of the rule allows for extremely complex logic to be adequately supported and implemented with minimal impact to the rule execution because the code can now execute in parallel pieces rather than in a serial manner. Alternatives could include neural network, genetic algorithm, or simulation code running on parallel machines (to decrease their own execution times) and have all of these systems to be able to feed simplistic outputs to another server that could compile all of the information into an even more advanced rule without impacting the execution time seen by the end user.

The lot based qualification (LBQ) system means all qualification wafers will be lot-based entities rather than wafer based. This process requires a donor FOUP to contain all wafers to be used for qualification purposes. The appropriate number of wafers is withdrawn from this FOUP and run through the process to be qualified and then measured. The trick from a scheduling perspective is how to merge these wafers into the main stream of production material when they are in a build and qualification state. For example: Exactly three monitor wafers must be included in every established furnace batch and must be present on the factory ops dispatch screen (which means that real-time dispatch (RTD) must schedule this material together). Another case in the situation relates to tool qualifications after maintenance; the scheduler must understand that a tool needs to be qualified and prioritize the LBQ lots to the top of that tool's queue. There is also the need to maintain an adequate inventory of these lots and to schedule the build operations when this inventory is low. This requirement greatly increases the amount of complexity of the system because of the number of unique “If . . . Then . . . ” situations.

The preferred embodiment methods include one or more of the following features: (1) low-complexity forecasting bottlenecks for essentially real-time use, (2) ranking product lots by slack to due date with both maximum and minimum caps, (3) dedicated scanner bottleneck feeds and other bottleneck slack ratio acceleration based on estimated time to bottleneck by fastest lot at logpoint, (4) parallel processing by reports and other rules across different hardware to accelerate rescheduling, (5) lot priority allows override of cycle-time-minimization in order to prevent other metric overflows, (6) lot pull by one of a group of parallel tools, (7) scanner optimization to minimize setups, and (8) multiple lot in a carrier batching.

These methods have advantages including a primary emphasis on minimizing average cycle time while accounting for factors such as cycle time variability, no lost capacity, customer/cycle time goal attainment, lot yield based on logpoint age issues, appropriate scheduling and support of the lot based qualification strategy, and to be capable of replacing the manufacturing specialist from the “What Next?” decision.

2. Scheduling

a. Theory

The preferred embodiment scheduling rules permit portions of the code to be easily turned off or changed in priority so that a rule that could be “trained” into behaving as expected by tweaking the emphasis on pieces of code affecting various timing and prioritizations and also so that management could change manufacturing policy quickly through the scheduler in addition to verbal instruction. Thus the rules use a consolidated priority value that is a conglomerate of all the sub functions; see following section 7. This structure allows one to turn off or adjust the weighting of each macro independently. The control this allows the fab scheduler to go from its prime focus being something like line balancing to maximizing outs, to minimizing cycle times without affecting the source code by turning off various inputs to the overall rule without rewriting any part of the actual rule.

The first step for the scheduler is generating a CDC (capacity data combination) report. This is a daily report that pulls in all parts per hour, process type, utilization, and other capacity data for every combination of device, logpoint, operation, and tool. In addition to this information, the program also calculates the same values using historical data from the previous three weeks and uses the CDC data to plug any holes in the actual calculated values. Using actuals over CDC data allows for lots to be differentiated at a higher-level so that the more important algorithms to the goal of minimizing average cycle time have more affect on the final output.

The CDC report output is then used as the input to three different macros, each with a separate design function. The first of these macros is the Slack Ratio macro which has two forms. Both of these forms calculates how far along the lot should be to meet its due date for its current age in the fab, however the first form simply returns a value of one if the lot is behind and a value of zero if it is not. This allows this function to be a very simple tiebreaker allowing other macros to have more affect on the scheduling output. This means that lots in danger of missing their due date out of the fab are prioritized higher than those that are not which helps ensure the customer attainment goal but working against the minimizing cycle time goal within that sub-group. The second of these forms calculates a slack ratio between where the lot should be at this time. This means that virtually all lots will have a unique value for their Slack Ratio giving this function (depending on its location in the rule hierarchy) great affect on the final schedule of the lots. This second form greatly assists in the reduction of cycle time variability and customer attainment, but it has greater negative affect on minimizing cycle time.

The second macro is the Bottleneck Slack Factor (see following section 5) that is primarily concerned with ensuring that each bottleneck tool has material to run at all times. This function works very similar to the slack time ratio in that it calculates the times to a bottleneck tool and sets a due date based on how quickly the bottleneck could exhaust all of the work in progress (WIP) presently at the tool and all the lots that should arrive at the bottleneck before the lots being investigated. This function calculates based off of time ordering and accelerates a logpoint group and only then, all the lots within that logpoint. If it is found that the WIP at a logpoint can be used to feed a potentially starving bottleneck, each lot will increase its priority by how fast it can reach the bottleneck thus eliminating the starvation situation as quickly as possible. Eliminating this danger quickly is very important as to not affect the other portions of the code. This portion of the code attempts to eliminate capacity loss without affecting any other goals, which, if achieved, would drive down cycle times but increase cycle time variability.

Bottlenecks are defined in a separate report (see following section 3) that calculates each tool's monthly capacity by examining total flow tool time consumed per lot, availability, number of occurrences in the line, and the number of back up tools that might be used instead. These values are calculated for every production flow in the fab and the bottom three tools by capacity and any additional tools that are within 5% of the bottom capacity are defined as bottlenecks. These values are calculated and output daily using the past twenty-one days of data as a basis for the report.

The third macro is the Gupta scheduling method. This method quickly generates a heuristically “optimum” schedule for every logpoint by comparing the speeds of various wafer counts, devices, flows, and tools. Essentially, the algorithm works by comparing the relative flow speed at the beginning of the logpoint versus the end. Lots that are faster at the beginning go first and those that are quicker at the back go last. Then the speeds of the flows are taken into account. The faster lots are then pushed out to the extremes of the schedule. The only goal of this algorithm is to decrease cycle time at the cost of all other goals. Therefore, it was placed at the bottom of the hierarchy of macros but should still have the greatest effect on the output of the fab of all of the macros. This is caused by the fact that unless the lot is falling behind its due date, set to a higher priority manually, or is needed to feed the bottlenecks, the Gupta value is used to schedule the lots.

These three macros (algorithms) are the primary drivers of a lot. There are still several other values that need to be taken into account for other manufacturing policies that help minimize cycle time (CT) variance and can increase process yield. This includes possibilities such as a lot should never be at a logpoint for longer than a day and should be pushed out of a logpoint in less than six hours. If a lot's logpoint age exceeds either of these thresholds, the lot will be slightly escalated, not enough to override some of the more critical information such as lot priority, but enough to be a substantial tiebreaker. Other variables that enter into the final schedule are entirely lot based in nature and include lot priority as the first sort, in rework/test wafers as the second sort, and logpoint age as the last. Thus, the scheduling of lots follows the hierarchy of: Lot Priority, In Rework/Test Wafer, logpoint age over a day, BSF, logpoint age over six hours, Slack Ratio, Gupta, and finally logpoint age. The BSF in combination with the Slack Ratio can override the in rework/test wafer sort in some occasions since this would be a production lot that is behind its due date and is needed to ensure that production is not permanently lost at the bottleneck and that escalating the rework/test wafer lot would not have either affect. The BSF was given priority over the Slack Ratio because a lot generally has significantly more opportunities to catch up to its due date by the end of the line than a lot headed to the bottleneck. Also, any time lost at a bottleneck tool cannot be made up if the fab is running at capacity and is therefore permanently lost.

Now that each lot is ranked for each tool, it is input into an algorithm to associate lots together to run in the most appropriate manner for a tool. This means forming eligible reticle trains in photo, matching qualifications in thin films and plasma, and creating batches of lots for the furnace and wet operations. Once these tool specific groups are created, each group is prioritized by a combination of the priorities set for each individual lot within the group. Once these groups are ranked, a schedule is generated and output. Brief descriptions on all of these methods can be found in the following sections.

b. Lot Information Report

The lot information report is run every thirty seconds and gathers all of the relevant information about the current state of the fab and lots and produces several of the prioritizing criteria for the lots and compiles them into one value for easy export to the tool specific rules for final schedule assembly and display.

The CDC Report pulls in a daily CDC extract containing tool information such as parts per hour, processing time, process type, expected utilization, and recipe for every combination of logpoint, operation, device, and tool and formats the information into a form that other macros can easily use. This report also calculates the average parts per hour and processing times for the past three weeks, excluding outlying data points, and uses this data instead of the CDC data where it exists. This report also provides the total cycle time for a device, current recipe, and the expected remaining cycle time for and combination of operation, logpoint, and device.

Dynamic Bottleneck Locator (see following section 3): One of the underlying limitations in some other dispatching rules is a lack in the understanding of the dynamic nature of capacity. The one caveat to this is to make the rule too dynamic and have it overreact to tools going down while still reacting to long term changes in capacity. Therefore, the preferred embodiment bottleneck locator uses demonstrated capacity from the previous twenty-one days and using that information to forecast the daily capacity of the fab.

This report does not have the accuracy of a simulation model, but it does have the advantage that it is dynamic, fast, and uses historical results to predict future performances rather than claimed capacities. It also has the ability to generate an immediate impact on newly installed tools, while tools with reliability problems will take time to affect the results accounting for not overweighing temporary tool problems.

The Slack Ratio Macro focuses on affecting the scheduling rule from minimizing cycle time to minimizing cycle time variance and meeting customer attainment. This macro is very dependant on the current goal cycle time. If this value is set too low, all lots will fail to meet those goals and will be escalated at the same rate. When this happens, this code will only add overhead and provide no additional information for decision-making. Also, with this goal set too high, no lots will ever fail to fall behind their schedule and once again this piece of code would effectively take itself out of the decision process. The point of the macro is to discriminate out which lots have consistently failed to meet their goal cycle times and to accelerate those lots so they get back into the correct time window with respect to the end of the line.

Bottleneck Slack Factor Macro (see following section 5) is to ensure that adequate manufacturing material is constantly being supplied to bottleneck tools by comparing the slack between a lots arrival time at the tool and the time it will take to exhaust all the lots that will arrive at the tool before the lot being analyzed. The method is very sensitive to having accurate cycle times and flows from CDC to accurately relate which lots need to be escalated first as well as knowledge of what tools are bottlenecks within the fab. This is why the dynamic bottleneck macro exists to increase the accuracy of what tools get fed and the reason for comparing actual data against the capacities listed in the CDC. Using the actuals and CDC minimizes the chances that the times used throughout the entire rule are based on bad historical data or outdated engineering inputs, greatly increasing the validity and accuracy of these macros.

Gupta Macro: Gupta's method of scheduling lots through multiple and variable processes was first published in 1971 as a means to quickly generate a heuristically optimal schedule based on the metrics of average cycle time and throughput. It works by comparing the cycle times at each step in a process and compares on lot's cycle time at each step with every other lot's cycle time. It finds lots that that are relatively faster at the beginning of the flow to the top of the schedule and those with finish the process relatively faster to the back of the schedule. The cycle time for the whole flow is the analyzed and the shorter the cycle times; the lots are pushed further to the extremes.

Compare the cycle time for the first operation in a logpoint to the final operation in the logpoint. If the first operation is faster, you provide a numerator of negative one. The denominator is found by finding the minimum of the process times of any two consecutive operations. To further add distinction between lots, if the process is a batch process, the denominator is multiplied by twenty-four and then divided by the current quantity signifying that you get a better pph value by making larger batches. In the case of non-batching tools, the denominator is multiplied by the current quantity and divided by twenty-four. This represents that a lot with less wafers moves faster than a lot with more wafers in a non-batching tool. Now that the final value is calculated, a simple ascending sort will give you the optimal schedule for this algorithm. These values are then passed to the scheduling rule as the final tiebreaker before logpoint age.

Numerator=IF(FirstOPNCT≧LastOPNCT)

THEN=−1

ELSE=1

Deno min ator=MINⱼ₌₁^{End-1}(OPNⱼCT+OPNⱼ₊₁CT)

$$Gupta = \frac{Numerator}{Denominator}$$

Next Reticle Macro: As a potential for creating larger reticle trains in the photo area, lots that would form a train in the photo area would be processed across parallel tool sets elsewhere in the flows in an attempt to have all of these lots arrive at the photo area at the same time. The benefit would be less reticle changes in the photo area but the drawback would include that at low production volumes, tools would not accumulate enough statistical data about a device's process on a tool to quickly locate potential problems that would affect yield.

The Furnace Report is a report that runs every ten minutes instead of the forty five second window that all other lot critical reports run at because furnace operations run at a slower pace than some other areas since run times can exceed six hours. The criticality of this report is to keep lots from running at hood operations if they will miss their time window. How this report works is it finds the run time by device and operation and compares that value to how long the lots that are currently running have been in process. It then locates any tools that are empty and qualified to run material. What happens next is that if a furnace will not empty in the time window period, all lots heading to that furnace have their lot priority multiplied by zero, essentially pushing them to the bottom of any list. If a furnace is within the time window, the lot priority is multiplied by one, if the furnace run will end in under the cycle time to get a complete load of lots there, the lot priority is multiplied by two, and if there is a furnace empty, it multiplies the value by three. This escalates the lots since idle furnace time is very valuable, but will not override any ranking criteria at the hood higher than BSF unless a lot at the hood can be batched with material already at the furnace operation. In this case only a P1 or P2 lot will override the schedule.

Alternatives of this report locate future material not at the furnace logpoint and decide whether it is better to idle the furnace and escalate lots further back in the line to increase the batch size and therefore throughput and therefore further minimizing average cycle time.

Furnace=IF(CurrentRun−FullRunTime≧TimeWindow)

THEN=0

ELSE=IF(TimeWindow≧CurrentRun−FullRunTime≧Time≧^{TimeWindow}/₂

THEN=1

ELSE=IF(FurnaceEmpty)

THEN=3

ELSE=2

Batch Type Assignment Macro establishes maximum and minimum values for lots, FOUPs, and wafers by tool type for each run. This macro also assigns each tool type to a specific type of processing such as batching, training, or cascading. All of these tool values are applied to each lot assigned to those tools and are used in the generation of the batches and trains and allows run rule control from a tool-based perspective.

Lot Info/Priorities Macro: All of the foregoing calculations are brought together and assembled into a meaningful order within this macro. Lots are also given their final lot priorities and logpoint age (and its associated modifiers on lot priority). These values are then pushed out to actual scheduling code; see the middle of FIG. 1.

LPAge_{Mult}=IF(LPAge>24 hrs)

THEN=2

ELSE=IF(LPAge>6 hrs)

THEN=1.1

ELSE=1

Lot Priority=SR*BNSF*Furnace*log point Age

c. Run and Scheduling Rules

The second piece of the entire rule formats the lots into appropriate schedules by tool. Since all of the lots have already established their priorities, tools assigned, and tool run rules, the only decisions that need to be made is how to group these lots and how to assign priorities to these groups in an appropriate manner as to not override the lot priorities.

The different types of groupings include cascades, batches, training, and no grouping. There are benefits to each of these groups and only particular tools can handle or benefit from the usage of these groups. Cascades refer to the practice of running lots back-to-back on a tool setup and qualified for one process, while not necessarily the same recipe, in an attempt to eliminate unnecessary tool setups. Reticle training is very similar to cascades in that it attempts to eliminate setups, however the requirements upon this grouping mechanism are much more stringent. To form an acceptable train, you most have the same reticle and recipe, not just the same setup qualification. In addition, there are photo specific requirements to break these groupings that are unique and forces this grouping into its own category for the purposes of this scheduler.

Batching also falls into to groups due to the simple fact that batches going to a furnace require the scheduling and dispatch of a pilot with the batch, where on wet tools pilots are not necessarily required to be grouped into the batch. Batch tools are any tools that are capable of processing multiple lots at the same time in the same chamber and therefore operate more efficiently when the batch size is larger.

Non-Batching Lots Macro: There are some tools that do not benefit from any specialized groupings and all of those tools fall under this macro to generate their schedule. This macro operates very simply by generating a batch priority equal to the lots priority and assigns a batch age equal to the lots logpoint age and the batches Gupta value is set to the lots value for this macro as well. This is done so that lots will have identical fields to lots dispatched through other macros. The lots in this area are then sorted by the criteria laid out in the previous section.

The Cascading macro creates groups of lots by equipment and operation. Typically, these groups are limited to ten lots where each group of ten will be assigned its own batch identification. The reason that we group these lots by operation rather than recipe is that the lots do not have the same recipe since the tool is setup for an operation and can run any recipe for that operation on the fly without a setup time. Eliminating the recipe restriction allows for larger, more flexible groups to be made. This increases the effect other algorithms have on these processes enhancing the throughput of the tool set.

Batch priorities in this case are set equal to the highest lot priority in any of these groups. This allows these cascades to be broken by high priority lots before the completion of the cascade grouping and gives no preference to the size of the group. The batch Gupta value is set at the average of the group. This is done since there is no guarantee that the lowest value will be scheduled first because of lot priorities, but rather implies that, on average, the lots contained within group “a” should be run before lots in group “b”. Batch log point age is set equal to the oldest lot in the group in an attempt to keep logpoint ages down by prioritizing material grouped with older lots.

Photolithography Reticle Training Macro (see following section 9) is to maximize scanner utilization by assembling groups of material that use the same recipe and then scheduling this groups in a method to meet the overall manufacturing environments priorities.

Batching Macro (see following section 10): Certain types of tools gain a productive advantage by batching together two or more lots in one process run. With these types of tools, it is advantageous to assemble material in a way that maximizes the tools capacity constraints for each run in order to maximize the capacity of the tool in number of wafers ran per unit time. In order to do this, it is sometime advisable to not run material in order to form a larger batch of material

TrackWorks Macro: Once all of the structuring of the lots and their groupings has taken place, real time dispatch reads in the tool state information. If the tool is down, real time dispatch will escalate all qualifying lot based qual wafers to the top of the queue so that they will be available for any possible qualification runs that the tool might have to perform. This macro also will input information that allows the end user to know that the tool is down by inputting a “tool down” message in place of the quantity and logpoint fields. Once this operation is complete, the final rule sort is completed based in the following order: P2 Switch, batch priority, batch Gupta, batch logpoint age, lot priority, lot Gupta, logpoint age, and then lot ID. Remember that all of the rework and hot lot information is contained within the lot priority and batch priority information and does not need to be used as sort criteria in the final rule output. Once this sort is complete, real time dispatch outputs the new schedule and the dispatch server sends the new schedule out to the factory operations program

3. Dynamic Bottleneck Forecasting

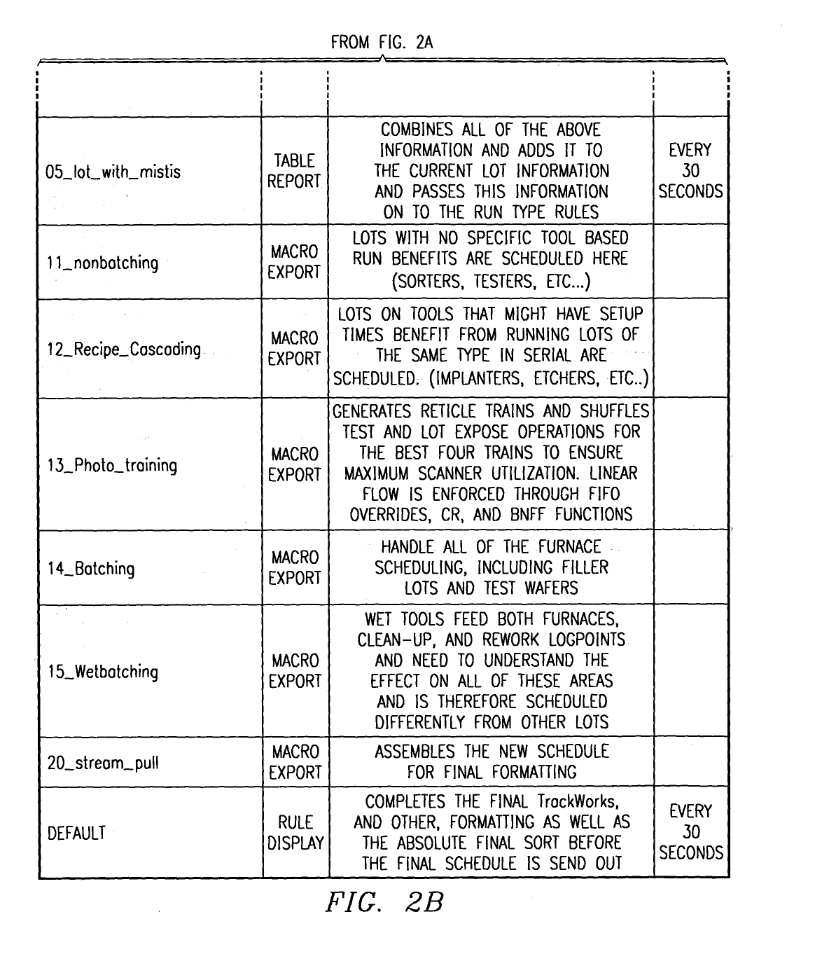

FIG. 3 illustrates the preferred embodiment dynamic forecasting methods which provide a list of capacity limiting, and a means to identify near capacity limiting, tools (bottlenecks) in order to provide a scheduler/planner with a means to recognize changes in capacity and to reroute material flow to maximize the production facilities available resources. The methods adapt to fit the reaction time of the manufacturing process in order to both adapt to the changing environment, but to not overreact and cause massive scheduling conflicts or massive redirections of work in progress.

The first step of the method retrieves the historical performance of each capital manufacturing resource; see upper lefthand portion of FIG. 3. The first portion of this performance data that needs to be obtained is a measure of resource availability over the appropriate time period. This metric is generated by summing the time that a resource is installed and capable of producing product and defining this as the baseline for all other tool calculations relating to time.

The next step obtains the total time of the baseline that a resource was capable of producing product. This will be known as the resource up time. Dividing the resource uptime by the baseline time, you would generate the baseline availability.

The third step finds the amount of baseline time that a tool was used to generate product. This value when divided by the baseline will result in the resource utilization and dividing this productive time by the resource up time will generate the effective utilization value of the tool. The more relevant measure for the purposes of this heuristic is product/tool utilization. This is found by dividing the time spent processing by the time the tool is up and run able material is present.

The next step takes the productive time and divides it by the effective utilization number. This calculation results in the total up time needed for the resource to meet its processing history. Taking this needed time and dividing it by the sum of the down time and the needed time will result in a downtime ratio.

$$Availability ≡ \frac{ToolTimeUp}{TotalToolTime} \qquad Utilization ≡ \frac{ToolTimeInProcess}{TotalToolTime}$$

$$EffectiveUtilization ≡ \frac{ToolTimeInProcess}{ToolTimeUp}$$

$$ProductToolUtilization ≡ \frac{ToolTimeInProcess}{ToolTimeUpAndMaterialPresent}$$

$$NeededTime ≡ \frac{ToolTimeInProcess}{ProductToolUtilization}$$

$$DownTimeRatio ≡ \frac{NeededTime}{NeededTime + ( TotalToolTime - ToolTimeUp )}$$

The fifth step combines all of the above-obtained values to generate a maximum productive time percentage, or maximum utilization. Initially, the needed time is subtracted from the available time for that resource. This quantity is then multiplied by the downtime rate. This new value is the additional amount of potential productive time was available for an increase in production capacity. Multiplied by the product/tool utilization, a representative of actual usable time emerges. When added to the needed time, this gives the theoretical productive time capacity of the tool. Dividing this value by the resource baseline time and the result is the theoretical maximum utilization or productive time availability for that resource.

AdditionalAvailableTime≡(ToolTimeUp−NeededTime)*DownTimeRatio*ProductToolUtilization

Theoretical ProductiveTime≡AdditionalAvailableTime+NeededTime

$$TheoreticalMaximumUtilization ≡ \frac{TheoreticalProductiveTime}{TotalToolTime}$$

With the theoretical resource time capacity defined above, the next result needed to identify total resource capacity is to identify the time needed to process one unit of the work in progress. This is done using the historical data from the appropriate rolling time period and using the values for processing time. If there is a known product with insufficient data history for the time period, a capacity database can be used to provide the information for these holes in the data. This data is then modified to meet the requirements of various different run type resources such as batching. An appropriate time needed per unit is found by taking the average processing time of that product and dividing it by the maximum number of units of the type that could be processed within that resource during that time.

Using these new process cycle times and divide them by a tools maximum utilization to get the theoretical real-time that is needed to be dedicated to that tool for that process for one unit of production. This value is then divided by the number of other resources that can also perform that operation and can take some of the necessary load away from the tool being analyzed. The resultant value will be called the needed process time.

$${NeededProcessTime}_{( Tool , Operation , product )} ≡ \frac{{UnitProcessTime}_{( Tool , Operation , Product )}}{{NumberOfParrallelTools}_{( Operation , Product )}}$$

By summing up each of these final needed processing times by each tool by product and the resultant value is the total average support time that a tool is dedicated to one unit of each product. This result will be referred to as the full product need time.

$${FullProductNeedTime}_{( Tool , Product )} ≡ {\sum }_{Operation = 1}^{End} {NeededProcessTime}_{( Tool , Operation , Product )}$$

Now the resultant product should appear as a comprehensive list of resources capabilities for each product.

If the full product need time were inverted and multiplied by a time period, the result would be the total number of wafers that the resource could complete during that given time period. Multiplying these results against the work in progress by the appropriate product indexing and then dividing the value by the total environment work in progress would result in a weighted capacity per unit time value. If these values were summed by each manufacturing resource, the result would be the average unit capacity for each resource. The resources with the lowest values in this capacity calculation would be classified as the capacity limiting resource.

$$\begin{matrix}{ResourceCapacity}_{( Tool )} ≡ {\sum }_{Product = 1}^{End} \frac{TimePeriod}{{FullProductNeedTime}_{( Tool , Product )}} * \\ \frac{{WIP}_{( Product )}}{{\sum }_{Product = 1}^{End} {WIP}_{( Product )}}\end{matrix}$$

BottleNeckTool≡MIN_{Tool=1}^{End}(Re sourceCapacity_{(Tool)})

Further, if each of these values are then multiplied by the unit work in progress of the current manufacturing environment and the sum up the resultant values by each tool. The final result will be an approximation of the time each tool would need to complete one complete turn of the fab inventory. The tools with the largest resultant times would be determined to be the bottlenecks.

Etid

$${OneWipTurnTime}_{( Tool )} ≡ {\sum }_{Product = 1}^{End} {FullProductNeedTime}_{( Tool , Product )} * {WIP}_{( Product )}$$

BottleNeckTool≡MAX_{Tool=1}^{End}(OneWipTurnTime_{(Tool)})

This method is a heuristic method and results in a fairly accurate solution without need to generate a full manufacturing facility simulation and is therefore more appropriate to adaptive scheduling procedures but not to long term capital purchasing.

4. Parallel Processing Reports

Preferred embodiment methods break up scheduling logic into parallel processes and cache those results and recombine them to form a coherent scheduling methodology. This gets around the constraints inherent in prior scheduling software in which each branch of the schedule is processed in series because of the inability to efficiently push out each process to parallel machines. The preferred embodiment structure allows scheduling logic to be run on parallel processors on the same machine or on multiple different computers allowing for much greater logic to be incorporated with minimal affect on the overall scheduling rule execution. This also allows you to run different timings on different pieces of logic. For an example, calculating fab capacity does not need to be executed as frequently as updating current material location.

The method in this case runs each piece of logic at the pace that the logic might change. An example of this is analyzing a furnace operation might take nine hours to complete and therefore its status does not need to be constantly updated, whereas production material states may change almost instantaneously and could cause a fatal misprocessing if not comprehended in time. FIG. 2 illustrates various reports (and macros) and the time intervals of their updates.

The process breaks up any scheduling rule and find which information needs to be grouped into like bunches. Each of these new bunches of code is then broken out into a separate reports set to run at a time interval appropriate to the information that the report is to assemble. These reports are then assembled together by a final piece of code to generate the final schedule. Since the output of the reports are persistent until the next report execution and allows variable execution times and frequencies moving the overall execution time to the time it takes to assemble the information and run the longest report that is on the shortest time interval. An example of this procedure for the present preferred implementation can be seen in FIG. 3.

5. Bottleneck Slack Ratio Acceleration:

The method described below generates a production schedule to minimize the risk of exhausting inventory levels at capacity limiting manufacturing resources (bottlenecks). This method works equally well with re-entrant and linear product flows, but is extremely dependent on accurate cycle time knowledge and bottleneck locations.

The first piece of code creates a method of analyzing the expected cycle times of various product flows in order to provide the heuristic with a method of comparing the speeds of diverse products so that the correct material is accelerated at the appropriate time. To do this, each process flow is inverted and then summed with the prior operation. This effectively gives an expected time to the end of the line for each product at every product step.

$$TimeOut ≡ {\sum }_{End}^{CurrentOperation} {CycleTime}_{( Product , Operation )}$$

The next portion of the code requires the indexing in of the bottleneck information against the above flows and time out information. This is done by indexing in a flag indicating a bottleneck operation at the appropriate portion of each flow. Each bottleneck operations time out and operational step information is then recorded for each device, along with the bottleneck operations cycle time.

IF equipment_ID==Bottle_Neck_ID

THEN Bottleneck_Operation_{(Product)}==Current_Operation_{(Product)}

Bottleneck_Cycle_Time_{(Product)}==Operation_Cycle_Time_{(Product)}

Bottleneck_Time_Out_{(Product)}==Time_Out_{(product)}

ELSE (No Operation)

This information is then indexed back into every operation that has production WIP. Situations where it is impossible for that material to supply the bottleneck are excluded.

IF Current_Operation=<Bottleneck_Operation

THEN ADD COLUMN (Bottleneck_Operation,_{(Product)}

Bottleneck_Cycle_Time_{(Product)}, Bottleneck_Time_Out_{(Product)})

ELSE (DELETE RECORD)

Then the current material at the bottlenecks are added together and multiplied by the bottleneck's cycle time. This represents the current time to exhaust the bottleneck, or the time available to transport more material to the area.

$$\begin{matrix}{BottlneckExhaustTime}_{Bottleneck} ≡ {\sum }_{Product = 1}^{End} {WIP}_{( Bottleneck , Product )} * \\ {BottleneckCycleTime}_{( Bottleneck , Product )}\end{matrix}$$

Each lot's arrival time at the bottleneck is then identified by subtracting its predicted time out of the fab by its associated bottleneck time out. This will provide a delta between the two forecasts that represents the arrival time to the bottleneck location. This also has the benefit of providing a means to compare line speeds and re-entrant flows throughout the production line.

ETA_{(Bottleneck,Lot)}≡Timeout_{(Product)}−Bottleneck_Time_Out_{(Product,Bottleneck)}

With these arrival times of all available production material, the material is sorted in ascending order of arrival time. This represents the expected order of arrival at the bottleneck. Each lots cycle time at the bottleneck is then added to the bottleneck exhaust time for the next lot. If the expected arrival time ever exceeds the bottleneck exhaust time, the product is then escalated by a ratio of its speed to the bottleneck in comparison to other lots in that current operation. The result of this is that in a situation where a bottleneck tool is threatened with material starvation, the rest of the fab will schedule the fastest material to re-supply the bottleneck.

Bott 1n eckExhaustTime_{(Bottleneck,Lot)}≡BottleneckExhaustTime_{(Bottleneck,Lot-1)}+BottleneckCycleTime_{(Lot-1)}

IF BottleneckExhaustTime_{(Bottleneck,Lot)}<ETA_{(Bottleneck,Lot)}

THEN

$$BottleneckSlackFactor ≡ 1 + \frac{( {BottleneckExhaustTime}_{( Bottleneck , Lot )} - {ETA}_{( Bottleneck , lot )} )}{{ETA}_{( Bottleneck , Lot )}}$$

ELSE

BottleneckSlackFactor≡1

The schedule would then be rune in decreasing order of the BottleneckSlackFactor.

6. Resource Pull Scheduling

With lot priorities being found on a global scale (see following section 7), a preferred embodiment form of scheduler does need to assign a schedule to a particular tool at any point of time, but rather produce a list of lots and priorities to a group of tools and allow the first resource that becomes available to take the highest priority lot. This implementation allows for maximum schedule flexibility to be maintained on each tool and quick reprioritization due to changing conditions in the manufacturing environment. Each piece of equipment can belong to several different lists of lots scheduled to various resource groups, but with the global lot prioritization, this problem is eliminated through the using the highest priority lot as the next in queue for all equipment.

7. Lot Priority

Lot priority combines the results of each scheduling macro into one numerical value so that all lots, regardless of logpoint, operation, tool, or priority can be compared to each other. For example, the combination could be

Lot priority=P*BNFF*CR*LogpointAge

where P is the initial lot priority assignment (e.g., 10000, 1000, or 0), BNFF is the bottleneck feed factor (e.g., in the range 1 to 4) and essentially is the bottleneck slack factor (BNSF), CR is the critical ratio which compares estimated remaining time in the fab with the time to the goal due date (e.g., in the range 1 to 2.5) and essentially is a slack ratio (SR), and LogpointAge reflects the time since the lot arrived at the log point (e.g., 1, 1.1, or 2).

Conversely, the combination could be as previously described in section 2b:

Lot priority=SR*BNSF*Furnace*LogpointAge

Where SR is the slack ratio and in the range 1 to 2.5, BNSF is the bottleneck slack factor, and Furnace is the furnace run status as a number in the range 0 to 3.

A control file orders and weights the inputs from the various lot flags and algorithms. In a preferred embodiment, the multipliers contain flags for late lots, long logpoint age, rework, priority, hold, time window, bottleneck feed, and due date considerations, but additional factors can be added and weighted as needed.

8. Reticle Training

The purpose of the reticle training method is to balance test wafer and lot expose operations in a manner that will maximize tool utilization on a tool with setup times, setup duration, and physical space limitations. This method could be used for any set-up of tools with setup flags for the production material.

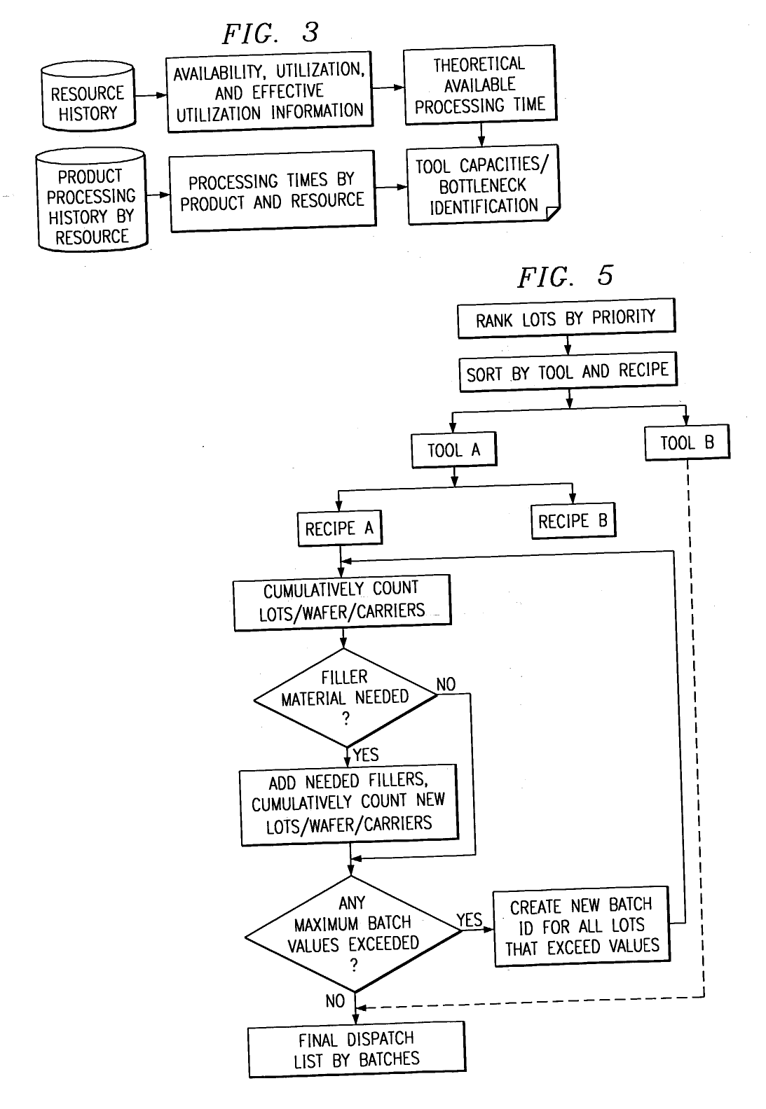

The first step of this method identifies the setup characteristics of the process. In the case of a scanner set-up, this will constitute reticles (Setup), maximum lots per reticle (train sizing), and physical space for material. In addition to that knowledge, the setup characteristics include the last setup process on the tool. Once this is known, proceed through the following steps (see FIG. 4):

Global Variables:

max_lot_setup—Maximum number of lots that can be run on one setup

max_space—Maximum space for lots on a tool

last_opn—Last operation ran by a tool

1) Sort all lots by descending levels of priority then

2) Cumulatively count lots by setup and tool (batch_lot_cnt)

3) Divide batch_lot_cnt by max_lot_setup (batch_ID) p1 4) Assign unique batch id's by grouping tools and batch_ID variables (unq_batch_ID)

5) Cumulate lot priorities by unq_batch_ID (batch_priority)

6) Identify highest logpoint age in the batch (batch_FIFO)

7) Filter off any material currently running on tools

8) Count unq_batch_ID groups by tool (shuffle_batch)

9) Split flows into shuffle_batch>=max_space (flow 1) and shuffle_batch<max_space (flow 2)

10) Separate flow 1 into a special priority, test wafer, or lot expose flows.

11) All special priority lots receive a value of zero for its shuffle_count

12) All lots of the opposite type of operation from the last_opn flag will be cumulatively counted and that count will be multiplied by two and then have one subtracted (shuffle_count)

13) All lots of the same type of operation from the last_opn flag will be cumulatively counted and that count will be multiplied by two (shuffle_count)

14) All lots in flow 2 are given a value of max_lot_setup*max_space (shuffle_count)

15) All lot flows are brought back together

Lots are then scheduled in order of minimum shuffle_count values with tie-breakers going to batch_priority and then batch_FIFO. If there is still a tie, lot priority and logpoint age are then used to break the tie.

When correctly combined with lot priorities, this system will shuffle the highest priority reticle trains through the tool in a manner to ensure that adequate test wafer and production runs are in process while also maximizing tool utilization. The method described above will work for all tools that have test and production operations with setup times.

9. Batching

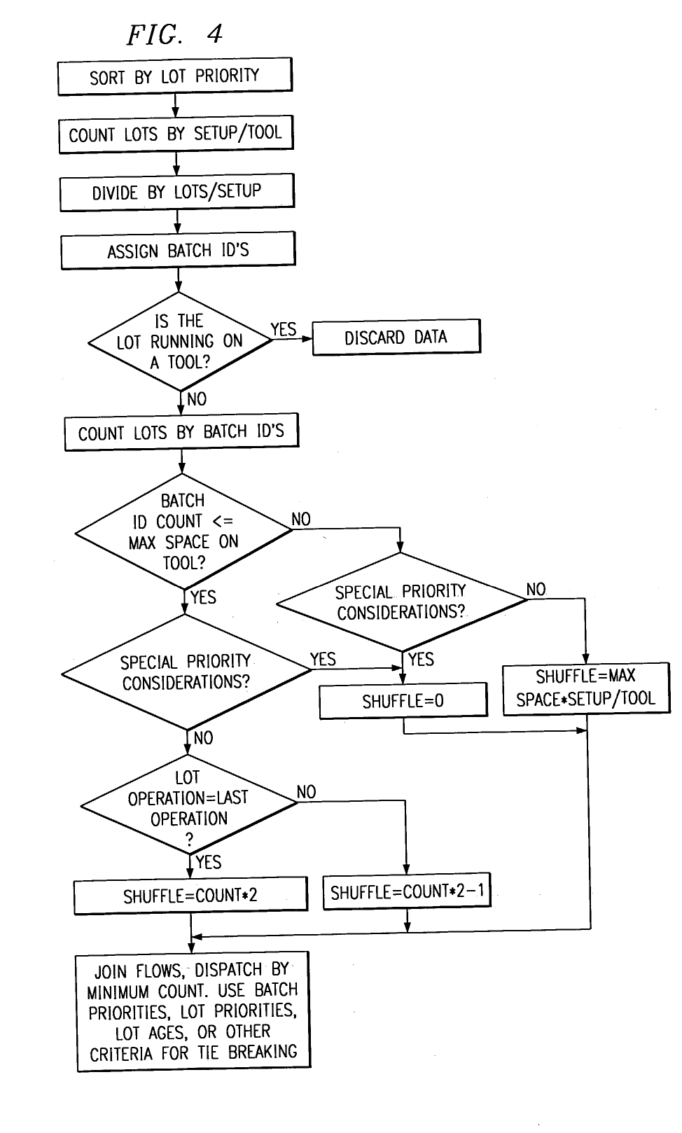

The preferred embodiment method shown in FIG. 5 creates batches for multiple lot processing with the constraints of carrier, wafer, and lot size maximums or minimums.

The first step of this process is to sort all of the lots by their lot priority value and separate groups of lot by which tool and recipe combination they belong to. At this point, the number of lots, wafers, and carriers is cumulatively counted. To each of these groups, the needed amount of filler material is then found if there are any minimums not fulfilled. The number of additional filler lots is then added to the totals found in the prior cumulating calculation. New batch ID's are then incrementally added to all lots that exceed the batch maximums and the process is repeated until all lots have a batch ID assigned to them. Pilot lots are then added to each batch by indexing a counter tied to the pilot lots to the batch ID's of the pilots for the associated tool group.

10. Modifications

The preferred embodiments may be modified in various ways while retaining the features of the overall structure because of its compartmentalization and containment of inputs

For example, the lot priority calculation can be modified by changing weightings of values, adding new values, or changing scales without needing to modify any other code beyond that which affects that value.

Another a example would be that the input of capacity numbers, bottleneck identification, additional lot priorities, or any other value used herein can be made from outside and used in this structure as long as its variable names match those used in the current embodiment of the code.

In addition to this, the batching and training algorithms can be easily modified to provide process scheduling improvements for any machine type with similar constraints

What is claimed is:

1. A method of scheduling, comprising the steps of:
(a) providing first and second reports with a time interval for updating said first report greater than a time interval for updating said second report; and
(b) rescheduling work in a factory according to current versions of said first and second reports.

2. The method of claim 1, wherein:
(a) said rescheduling includes dynamic bottleneck estimation.
